(19) United States
(12) Patent Application Publication
(10) Pub. No.: US 2016/0158676 A1
(43) Pub. Date: Jun. 9, 2016

(54) METHOD AND APPARATUS FOR MANIPULATING COMPONENTS OF A FILTRATION SYSTEM

(71) Applicant: Laboratoire Français du Fractionnement et des Biotechnologies, Les Ulis (FR)

(72) Inventors: Nathan Hawkins, Auburn, MA (US); Thomas E. Smith, Brimfield, MA (US)

(21) Appl. No.: 14/955,741

(22) Filed: Dec. 1, 2015

Related U.S. Application Data
(60) Provisional application No. 62/085,903, filed on Dec. 1, 2014.

(51) Int. Cl. B01D 29/96; B01D 29/41; B01D 29/50; B65G 7/12

(52) U.S. Cl. CPC B01D 29/96; B65G 7/12; B01D 29/41; B01D 29/50

(57) ABSTRACT

The present disclosure relates to a tool and methods of using the tool to physically manipulate one or more filtration components, such as filter packs including stacked filtration discs. The tool may include two arms pivotally coupled to another, and may also have respective gripping portions configured to grasp an appropriate region of a filtration component. The arms may be movable toward and away from one another between grasping and non-grasping positions. When in the grasping position, the gripping portions may engage with a complementary coupling member of the filtration component(s). To separate one filtration component from another, the tool may be manipulated so as to decouple and lift the filtration component from a substrate.

### RELATED APPLICATIONS

This application claims the benefit under 35 U.S.C. §119(e) of U.S. Provisional Application Ser. No. 62/085,903, entitled “Method and Apparatus For Manipulating Components of a Filtration System,” filed on Dec. 1, 2014, which is herein incorporated by reference in its entirety.

### BACKGROUND

1. Field

Aspects herein relate to methods and apparatuses for manipulating components of a filtration system.

2. Discussion of Related Art

Filtration is a process that involves physical separation of materials having certain characteristics, such as those that differ in size, phase (e.g., separation of solid from fluid), other properties, etc. For instance, a filter media through which only a fluid or solid of a small enough size can pass may be positioned at the entrance of a feed, resulting in the formation of a filtrate material on one side of the filter media and a retentate material on the other side. That is, a portion of the feed passes through the filter media as permeate or filtrate, while the remaining portion of the feed material is retained on the entry side of the filter media as retentate.

There are a number of different types of flow filtration. For instance, in direct flow filtration, the feed is flowed directly toward the filter media (i.e., substantially perpendicular to the face of the filter media). In tangential flow filtration, the majority of the feed flows tangentially across the surface of the filter media, rather than toward the filter media. As feed travels across the surface of the filter media, a portion of the feed may pass through, or adhere, to the filter media. Both types of flow filtration involve separation of filtrate and retentate material. Though, in tangential flow filtration systems, the tendency for the filter media to be clogged is reduced or otherwise delayed in comparison to more traditional direct flow filtration systems.

In some cases, for either direct or tangential flow filtration systems, a net positive pressure is applied between the retentate (entry) side and the permeate (exit) side of the filter media, urging the feed toward the filter media, so as to produce a filtrate on the permeate side.

### SUMMARY

Aspects described herein relate to physically manipulating components of a filtration system (e.g., installing/separating packs of stacked filtration discs). As noted above, in various configurations of flow filtration, feed material is flowed continuously toward and/or across the filter media. After a prolonged or otherwise sufficient period of time, filter media used during the filtration process may accumulate a substantial amount of retentate material, calling for periodic cleaning and/or replacement of the filter media. Though, when the filter media is used to the point where it requires cleaning or replacement, the accumulation of retentate material thereon may be unpleasant and, at times, unsafe/hazardous to handle.

For some applications, filtration components include a filter pack having a number of filtration discs stacked together (e.g. in a lenticular arrangement), and replacement thereof involves rotating and lifting large, bulky discs relative to one another. At times, physical manipulation of such discs manually (by hand) can be unwieldy, unsafe and/or repulsive. Due to such concerns, it may be preferable for filtration components of the system to be manipulated using a tool that helps to minimize or otherwise reduce personal exposure to certain components.

In some embodiments, a tool having two arms that are pivotally coupled, and having respective gripping portions, may be used to manipulate and/or handle the filtration component(s). The gripping portions may be movable toward and away from one another, for example, by appropriate handling of the arms, between grasping and non-grasping positions. When in the grasping position, the gripping portions of the arms may be in alignment and engaged with a complementary coupling member of one or more filtration components. In certain embodiments, the tool may then be used to decouple and lift the filtration component(s), via the two arms engaged with the coupling member, from a substrate.

In an illustrative embodiment, a method of manipulating components of a filtration system is provided. The method includes moving two adjacent arms of a tool away from one another to a non-grasping position, each of the arms having a respective gripping portion located along the arm. The method further includes positioning the gripping portions of each of the arms of the tool into alignment about a coupling member of at least one filtration component. The method includes moving the two adjacent arms of the tool toward one another to a grasping position such that the respective gripping portions of each of the arms engages with the coupling member of the at least one filtration component. The method also includes lifting the tool and the at least one filtration component, via the two adjacent arms engaged with the coupling member, from a substrate.

In another illustrative embodiment, a filtration system is provided. The system includes a first filter pack having a first plurality of stacked filtration discs and a first coupling member located at an upper region of the first filter pack. The system further includes a second filter pack having a second plurality of stacked filtration discs and a second coupling member located at an upper region of the second filter pack, the second coupling member constructed and arranged to engage with a lower region of the first filter pack. The system also includes a tool having adjacent arms constructed and arranged to engage with the first coupling member of the first filter pack, for lifting and separating the first filter pack from the second filter pack.

In another illustrative embodiment, a tool for manipulating components of a filtration system is provided. The tool includes a first arm having a first gripping portion. The tool further includes a second arm having a second gripping portion, the first and second arms pivotally coupled to one another such that the first and second gripping portions are movable away from one another to a non-grasping position and movable toward one another to a grasping position, wherein the first and second arms are constructed and arranged to engage with a coupling member of at least one filtration component upon reaching the grasping position, for decoupling and lifting of the at least one filtration component from a substrate.

Various embodiments of the present disclosure provide certain advantages. Not all embodiments of the present disclosure share the same advantages and those that do may not share them under all circumstances. Various embodiments described may be used in combination and may provide additive benefits.

Further features and advantages of the present disclosure, as well as the structure of various embodiments of the present disclosure are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the present disclosure will now be described, by way of example, with reference to the accompanying drawings, in which:

FIG. 1 shows a top view of a tool in accordance with an embodiment;

FIG. 2 depicts a side view of the tool of FIG. 1;

FIG. 3 shows a cross-sectional view of the tool of FIGS. 1-2;

FIG. 4 illustrates a perspective view of a tool in a first position in accordance with an embodiment;

FIG. 5 depicts a perspective view of the tool of FIG. 4 in a second position;

FIG. 6 illustrates a perspective view of a filtration system in accordance with an embodiment;

FIG. 7 shows a perspective view of coupling members of a filtration system in accordance with an embodiment;

FIG. 8 depicts a perspective view of another filtration system in accordance with an embodiment;

FIG. 9 illustrates tools in use with a filtration system in accordance with an embodiment; and

FIG. 10 shows tools in use with a filtration system in accordance with an embodiment.

### DETAILED DESCRIPTION

The present disclosure relates to methods and apparatuses for physical manipulation (e.g., separation, coupling, decoupling, stacking, etc.) of various components of a filtration system. As noted above, during use over a period of time, various components of a filtration system may build up significant amounts of retentate material. For instance, the filter media (e.g., stacked filtration discs of a direct and/or tangential flow filtration system) may accumulate an excess amount of material (e.g., globular particles, aggregates, fats, biological materials, waste material, etc.) that tend to clog or otherwise impede the overall filtration process. Accordingly, after a certain period of time and/or level of use, it may be preferable, or required, for the filter media to be replaced. Though, as discussed above, the accumulated material on or around the filter media may be unpleasant and/or cumbersome to handle and, thus, it may be undesirable for personnel (e.g., workers, operators, etc.) to come into direct contact or other exposure thereto.

In various embodiments, a clamping tool may be employed to physically replace, lift, align, couple, decouple, handle and/or manipulate components of a filtration system, while minimizing or otherwise reducing personal exposure. The tool may be operated and used by workers and/or automated machines. The tool may have two long arms that are pivotally coupled at one end of the tool, with both arms extending toward an opposite end so as to allow for the arms to clamp on to an object. Each of the arms may include a gripping portion located at a suitable position along the arm (e.g., midway between opposite ends), configured for appropriately manipulating (e.g., gripping, rotating, pulling, lifting, separating, handling, etc.) the filtration component(s).

Handling or otherwise repositioning the arms may involve bringing the gripping portions toward and/or away from one another, for example, moving the arms between grasping and non-grasping positions. For instance, in an embodiment, when the tool is positioned so as to be in suitable alignment with a filtration component, the tool may be placed in a grasping position, where the gripping portions of the tool are engaged with a filtration component, for example, a complementary coupling member corresponding to a pack of stacked filtration discs. Once suitably engaged, the appropriate personnel and/or machine may operate the tool to suitably manipulate (e.g., rotate, lift, separate, couple, decouple, etc.) and position the filtration component(s).

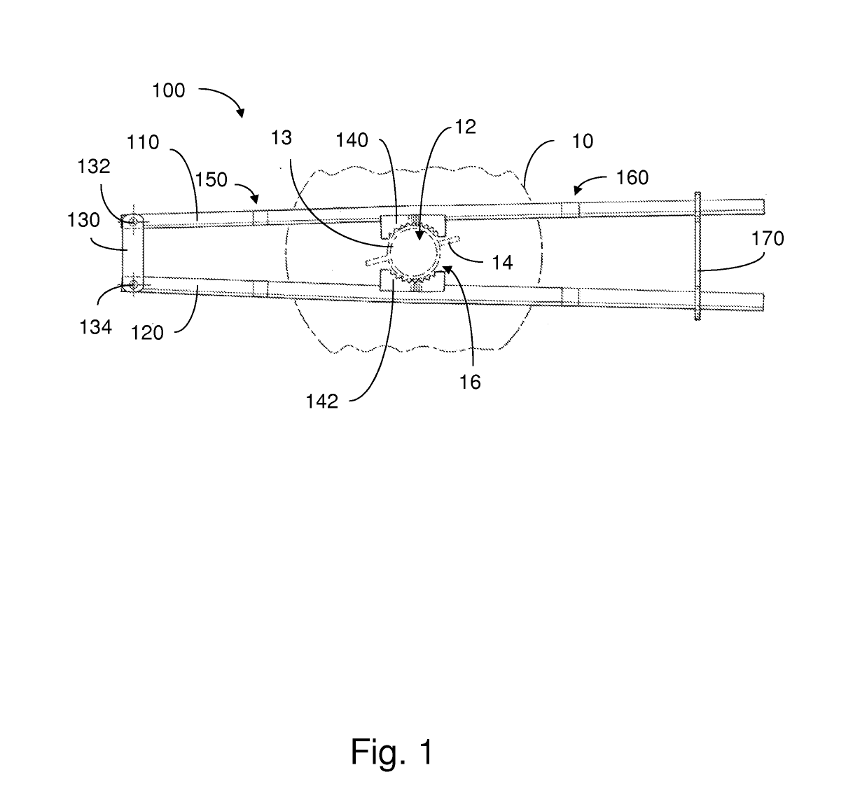

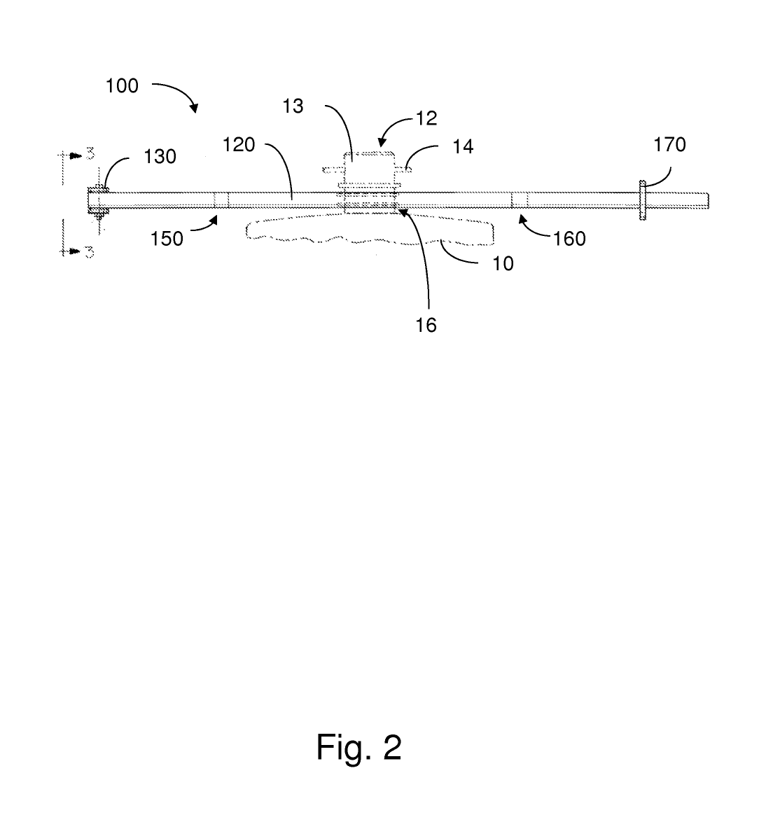

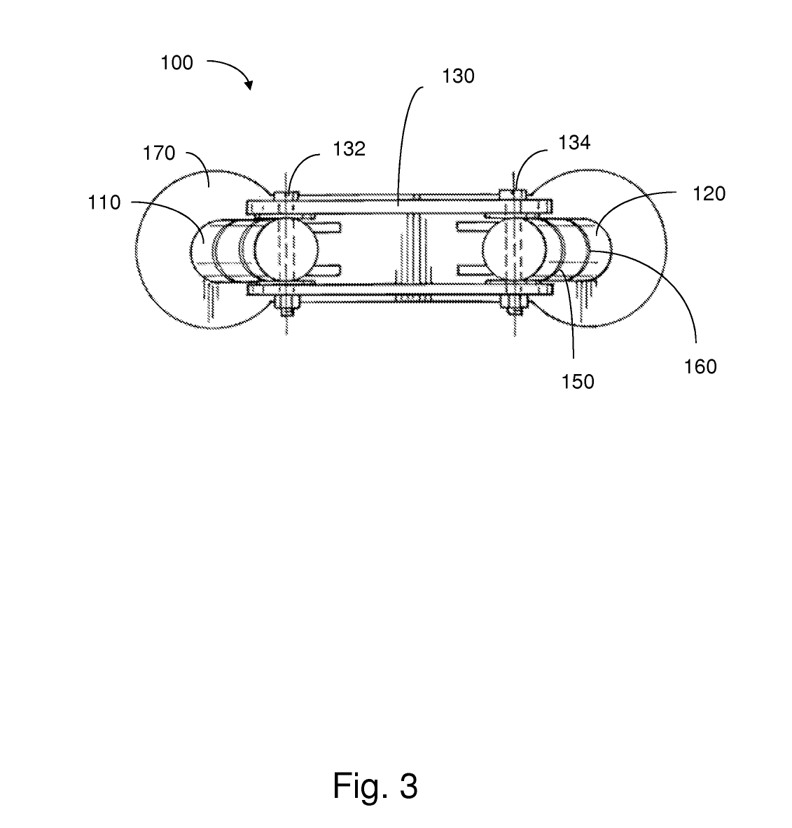

FIGS. 1-3 illustrate various views of an embodiment of a tool 100 for manipulating one or more filtration components. Depicted in the dashed lines, filtration components may include a filter pack 10 (e.g., stack of filtration discs used in direct/tangential flow filtration systems) having a coupling member 12, which may be structured to engage with other filter packs and/or a tool, for manipulation and/or stabilization of the pack 10 relative to a substrate (e.g., other filter packs, underlying base structure, etc.). As further shown, the coupling member 12 includes a head 13 and a rod 14 extending from the head. As described further below, for some embodiments, the head 13 and rod 14 may be suitably structured for attachment or coupling with a complementary coupling member of another filter pack. The coupling member 12 further includes a gripping region 16 appropriate for gripping thereof, for example, by a suitable tool 100.

In this embodiment, the tool 100 includes a first arm 110 and a second arm 120, each provided as an elongated rod that is pivotally coupled to the other via a support member 130. The support member 130 has two pivoting joints 132, 134, each corresponding to a respective arm 110, 120, for rotation of the arm about a pivot point. As shown, the first arm 110 may rotate about the pivoting joint 132 and the second arm 120 may rotate about the pivoting joint 134. For example, an operator may grasp the respective handle ends of the arms, located opposite the support member 130, and spread the arms apart, or bring the arms closer together, or manipulate the tool in another way.

It can be appreciated that the arms may have any suitable shape and are not required to be elongated rods. In some cases, portions of the arms may have an arcuate shape and/or may have angled regions, for example, to provide ergonomic benefits for the user. The tool may also be configured such that the arms move relative to one another without a pivotal coupling. For instance, the arms may be coupled via a spring and/or ratcheted configuration that allows for movement of the arms back and forth in discrete steps. In some embodiments, the tool includes a motorized portion or has an appropriate actuator that controls movement of the arms.

In some cases, as shown in this embodiment, the arms 110, 120 may be independently movable back and forth relative to one another. That is, movement of one of the arms does not affect movement of the other arm. As an example, an operator may grasp the first and second arms 110, 120 at respective handles, or ends opposite the support member 130, to spread the arms apart or bring the arms together, for example, moving between non-grasping and grasping positions. For some embodiments, the arms 110, 120 may be coupled so as to move together in concert where, for example, movement of the first arm 110 may cause movement of the second arm 120, or vice versa.

FIG. 1 depicts the first and second arms 110, 120 to be coupled via a support member 130, though, for some embodiments, the first and second arms may be directly attached to one another. For example, while not shown, respective ends of the first and second arms may form a pivoting joint, or other type of connection therebetween, that provides for rotation or other movement of the arms relative to each other.

The tool 100 further includes gripping portions 140, 142 located at suitable regions along the respective arms 110, 120. The gripping portions 140, 142 are constructed to appropriately grasp an object, such as a filtration component. As depicted, the gripping portion 140 of the first arm 110 is positioned approximately midway along the length of the arm 110, substantially equidistant from opposite ends of the arm. The gripping portion 142 of the second arm 120 may be similarly positioned, in a complementary manner to gripping portion 140 so as to be able to provide a firm grip on the target object.

As further shown, each of the gripping portions 140, 142 includes an arcuate profile that is concave along the side of the gripping portion that faces the other. In some embodiments, and as also depicted in the figures, the arcuate profile has an appropriately serrated edge, which may also help to provide for a firm grip of the object held between the arms. Accordingly, the gripping portions 140, 142 may be particularly suitable for grasping an object that is substantially cylindrical in shape.

It can be appreciated that gripping portions of the tool may have any suitable profile or shape that may allow for suitable grasping of a target object. For example, the gripping portion may be shaped, irregularly or regularly, so as to match a particular shape of the object to the grasped. Or, in some embodiments, the gripping portion may include an attachment or coupling member (e.g., protrusion, tab, slot, insert, recess, keying interface, etc.) that is complementary to a corresponding attachment or coupling member of the object to be grasped (e.g., coupling member and/or region of a filtration component to be gripped), for firmly holding, rotating, handling, lifting or otherwise manipulating the position of the object.

The tool 100 further includes position indicators 150, 160 for assisting an operator in appropriately aligning the tool with the object to be grasped. Such alignment may be preferable, for example, so that the gripping portions 140, 142 of the tool are suitably positioned to establish a firm grasp on the object. Also, the object to be grasped and lifted may be relatively heavy and cumbersome, and so suitable balancing of the tool on either side of the object may be desirable.

In some embodiments, the position indicators 150, 160 may be distinct markings (e.g., colored, darkened markings) on each of the arms 110, 120 that correspond to edges or other alignment features of the target object, for appropriate balancing thereof upon lifting. For example, as described further below, prior to placement in a grasping position, the tool 100 may be handled and oriented such that the respective gripping portions 140, 142 are placed in a suitable position to grasp the object. Accordingly, for certain embodiments, the position indicators 150, 160 may provide a reference guide that may be used for appropriately aligning the gripping portions with a corresponding coupling member or region of the object to be grasped.

In some embodiments, the tool 100 also includes a retaining member 170, for holding the tool in a grasping position. An operator using the tool to grasp and lift large/heavy objects may grow weary from long periods of exertion. When grasping and lifting a heavy object, it may become tiresome for the operator to continuously squeeze the arms of the tool toward one another to ensure that the object does not become loose and/or fall from its grip.

Accordingly, the operator may place the tool into suitable alignment with the object, squeeze the arms together, so as to establish a firm grip thereon, and then install a retaining member 170 between the arms, to hold the tool in place while maintaining a firm grip. As a result, the operator may relax his/her overall level of effort that may have been exerted in forcing the arms toward one another.

Any suitable retaining member may be used. For example, as shown in the figures, the retaining member may include openings through which the arms may extend, and a bar that rigidly holds the arms in place. Alternatively, or in addition, the retaining member may include a ratchet arrangement where the distance between the arms may be selectively and discretely fixed depending on the ratcheted setting. Or, the retaining member may include separate parts that may be configured to form a locked or unlocked configuration (e.g., mutually complementary keying interface, bayonet and socket, rivets, etc.), depending on whether the operator would like the arms to remain fixed in place. For example, one part of the retaining member may extend from the first arm 110 and the other part of the retaining member may extend from the second arm 120 and, when the tool is placed in the grasping position, the separate parts of the retaining member may be locked together, attached or otherwise coupled together.

In some embodiments, when placed in the grasping position, the arms 110, 120 are oriented so as to extend in respective directions substantially parallel to one another. Though, it can be appreciated that the grasping position may involve orienting the arms in a different manner, for example, such that the arms form an oblique angle relative to one another, or in accordance with the particular shape(s) of the arm(s).

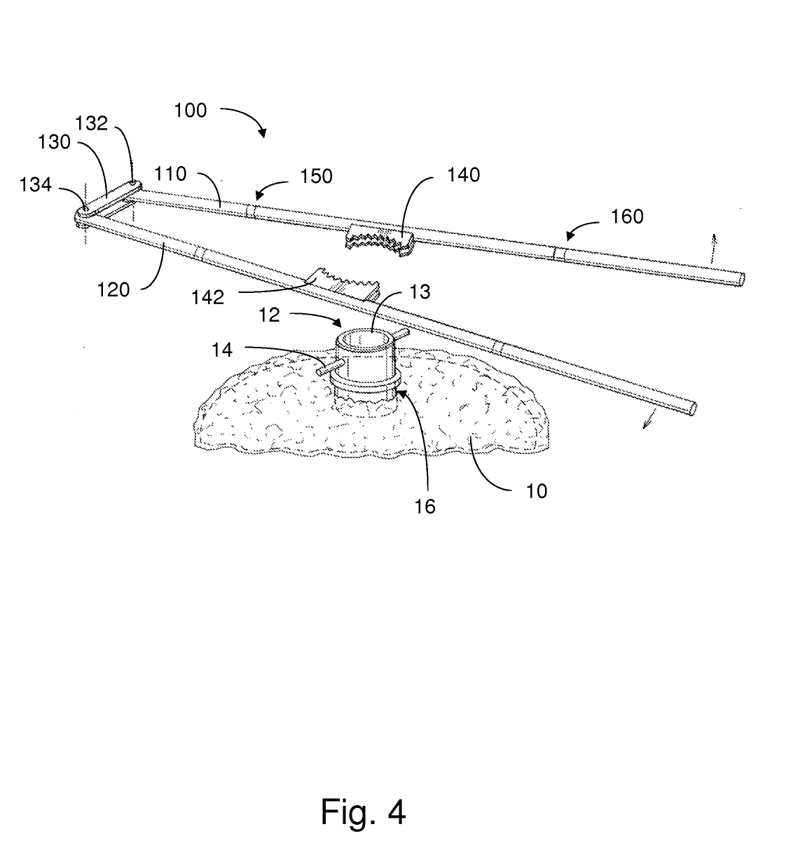

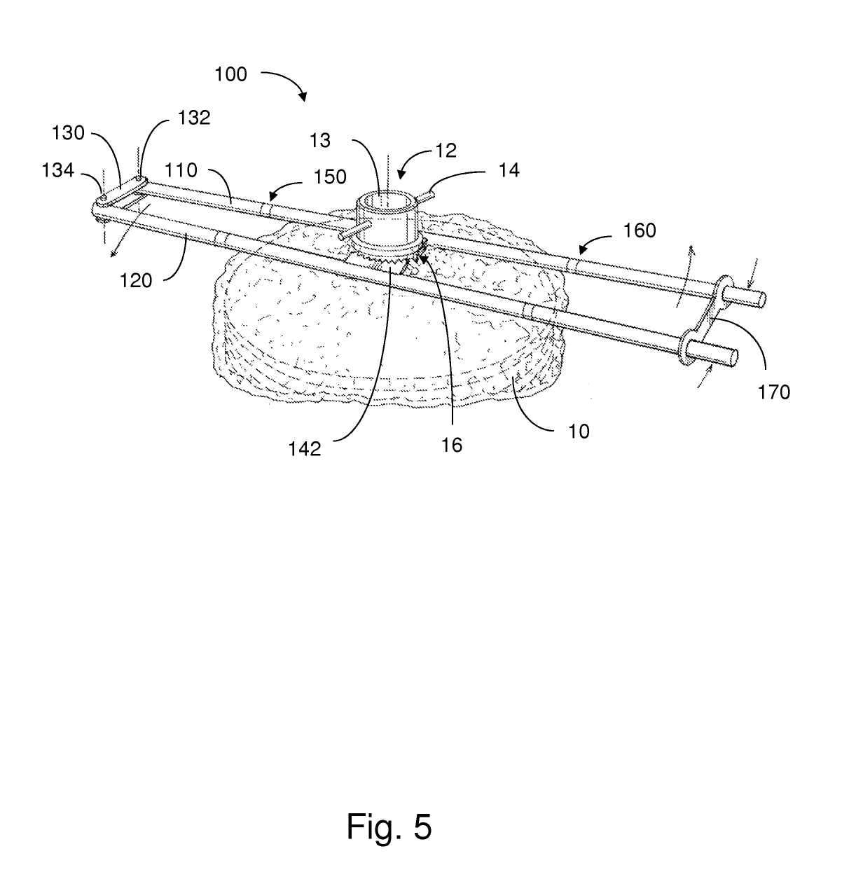

FIGS. 4 and 5 depict an embodiment of a tool 100 in use, for grasping and handling a filtration component 10. Here, the filtration component 10 is illustrated as a used stack of filtration discs that have accumulated a sufficient amount of retentate material (e.g., milk laden fats, cell debris, insoluble milk proteins, nucleic acid precipitate, biological deposits, other residual materials) caked on or otherwise agglomerated on the filter surface that would require replacement of the discs.

As a skilled person in the art may appreciate, manually grasping the filtration discs or coupling member 12 by the head 13 and/or rod 14, and/or coming into contact with the retentate material, may be associated with a number of health and safety concerns. Thus, when the system is suitably drained and ready for disassembly, the tool 100 may be used to grasp, decouple and lift the filtration component 10 from an underlying substrate (e.g., another stack of filtration discs) without an operator having to be directly exposed to the filtration component or the residual material on the component.

FIG. 4 shows the tool 100 in a non-grasping position, prior to engagement of the tool and the filtration component 10. Here, the arms 110, 120 are spread apart and the tool 100 is not yet placed in contact with the filtration component 10. As shown by the direction of the arrows illustrated at the handle ends of the arms, the two adjacent arms 110, 120 may be pivoted away from one another to the non-grasping position.

For instance, an operator or machine may clutch the respective handle ends of the arms and pull the arms apart from each other, making additional room in the space in between and defined by the respective gripping portions 140, 142. The tool 100 may then be aligned (e.g., using the position indicators 150, 160 as a reference with respect to the edge of the filter pack) with the filtration component 10 such that the coupling member 12 is suitably situated within the region provided by the gripping portions 140, 142.

Upon appropriate alignment, the arms 110, 120 of the tool are squeezed together so that the gripping portions 140, 142 firmly clamp on to the corresponding gripping region 16 of the coupling member 12. As shown in FIG. 5, the tool 100 is placed in a grasping position, as given by the direction of the arrows illustrated at the handle ends of the arms. Here, the serrated edges of the arcuate gripping portions 140, 142 of the tool are used to secure the tool tightly on to the cylindrical core of the coupling member 12. An optional retaining member 170 may be used to maintain the tool 100 in the grasping position, firmly holding the filtration component in place between gripping portions 140, 142.

FIG. 5 further shows another pair of arrows that illustrate rotation of the tool in a counter-clockwise direction (when looking down on to the system from above), which results in decoupling of the filtration component 10 from an underlying substrate (e.g., another filtration component, stack of filtration discs, base support plate or coupling component, etc.). In various embodiments, the filtration component may be coupled to and decoupled from an underlying substrate by any suitable manner. As discussed further below, the filtration component may be coupled and decoupled with the substrate by rotating, pushing/pulling, locking/unlocking, or another appropriate type of physical manipulation. Here, prior to lifting the filtration component up from the substrate, the tool and the coupling member are rotated to a suitable position where the filtration component may be lifted therefrom.

It can be appreciated that various embodiments of the tool may be used to manipulate any suitable object. As discussed above, the tool may be used to handle various filtration components, for example, installing, adding and/or removing one or more components to or from a filtration system. The tool may be used to manipulate other non-filtration components as well.

In some embodiments, a filtration component may include a number of filtration discs (e.g., lenticular filter media) that are stacked one over the other for use in a direct and/or tangential flow filtration system. For example, in some cases, the filtration discs may be structured so as to have any suitable diameter, for example, approximately 12 inches, 16 inches in diameter, or any other appropriate diameter. As discussed above, the filtration discs can become quite heavy (e.g., approximately 45 lbs. or greater) and unpleasant when loaded with residual retentate material.

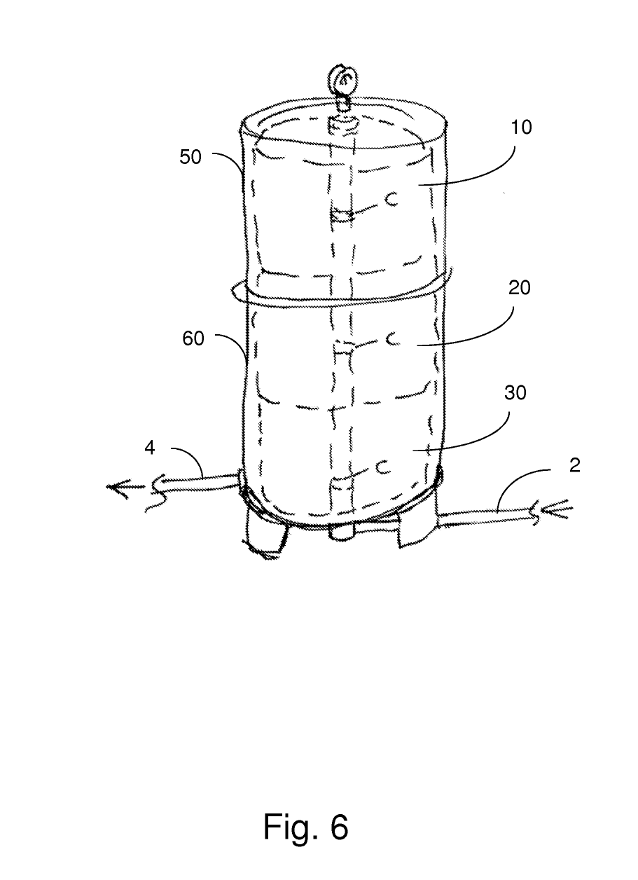

FIG. 6 depicts a direct flow filtration system having three filter packs 10, 20, 30 of stacked filtration discs (e.g., approximately six filtration discs provided in a filter pack). In this embodiment, each filter pack has a number of filtration discs arranged so as to exhibit a lenticular structure, with a core that extends through the packs. The core may have any suitable structure, with appropriate dimensions and materials. For example, the core may include a cylindrical hub-like configuration around and from which the filter media may surround and extend. In some embodiments, the core has a diameter of between 1 inch and 6 inches (e.g., approximately 3 inches). In some embodiments, the core includes any suitable material, for example, polypropylene, polyester, polyimide, polyamide, etc.

At respective coupling regions C, the first pack 10 is coupled to the second filter pack 20 which is, in turn, coupled to a third filter pack 30. Each of the packs have respective coupling members for appropriate attachment therebetween. It can be appreciated that any suitable number of filter packs may be coupled together, in any suitable configuration.

Upon suitable assembly with one another, the filtration discs are configured for direct flow filtration where feed material is flowed toward the system via inlet 2 and away from the system via outlet 4. Any suitable pumping system may be used to cause flow of feed into the filtration system via the inlet(s), through the filter media, and out of the system via the outlet(s). Each of the inlet(s) and/or outlet(s) may have a respective valve arrangement associated therewith. As shown, the inlet 2 and/or outlet 4 may be coupled to the filter media, for example, at the lower end of the filtration system via a suitable sealed gasket arrangement.

Any appropriate filter media may be used. For example, as discussed further below, the filter media may or may not be pharmaceutical grade media. In some embodiments, the filter media is cellulose based (e.g., predominantly cellulose, made from 100% cellulose; and/or with or without resins, binders, fillers or synthetic fibers). In some embodiments, the filter media includes other materials, such as diatomaceous earth/rock, perlite, activated carbon, amongst others.

The filter media may exhibit a suitable nominal retention rating, i.e., size of particle that is able to pass through the media, for example, less than 1 micron, approximately 0.25 microns, approximately 1 micron, between 1 micron and 10 microns, approximately 10 microns, greater than 10 microns, or other appropriate size(s).

In some embodiments, the filter media may be useful in filtering pharmaceutical products such as syrup, milk, parenteral (e.g., large volume and/or small volume parenterals, as known in the art), active pharmaceutical ingredients, colloidal materials, biological products (e.g., blood plasma, blood fractions, sera, fermentation broths, cell culture media, veterinary products, cell debris, proteins, etc.), and/or other appropriate materials.

The system may also include added support around the filtration discs. FIG. 6 further shows an upper support sleeve 50 and a lower support sleeve 60, each surrounding the stack(s) of filtration discs, providing a domed support structure that encloses the filter media. As shown in FIG. 6, the upper and lower support sleeves 50, 60 may be cylindrical, conforming to the overall shape of the filtration discs. Such sleeves may provide structural support to the filtration discs and their mutual couplings, as well as containment of the materials associated with the filtration discs. It can be appreciated that other support and containment configurations may be possible and are not required for certain embodiments of the present disclosure.

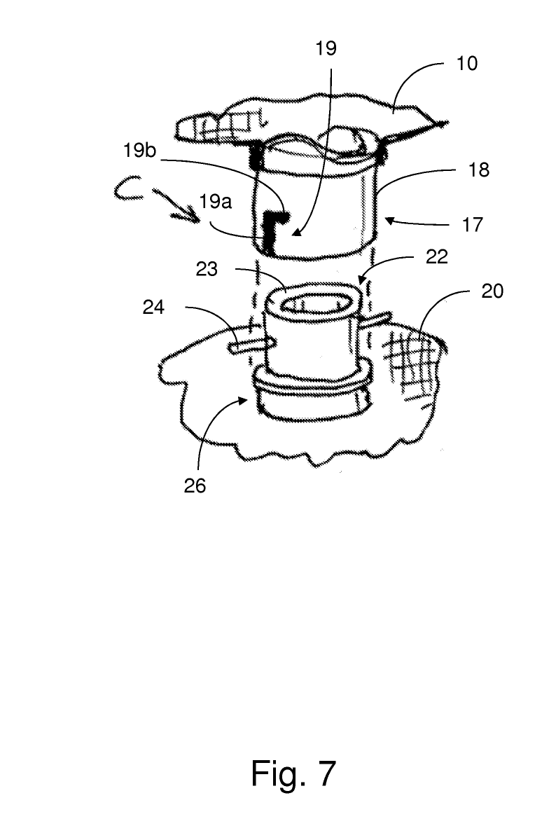

FIG. 7 illustrates an illustrative embodiment of a coupling formed between the first filter pack 10 and second filter pack 20 of filtration discs. Here, the bottom of the first filter pack 10 includes a lower coupling member 17 and the top of the second filter pack 20 includes an upper coupling member 22.

The upper coupling member 22 is similar in structure to the coupling member 12 previously shown and described herein. That is, the upper coupling member 22 of the second filter pack 20 includes a head 23 and a rod 24 extending from the head. The upper coupling member 22 further includes a gripping region 26 to which a tool may suitably engage.

The lower coupling member 17 of the first filter pack 10 includes a casing 18 and a slot 19 into which a corresponding rod, insert or protrusion may enter. As shown, the slot 19 includes an entryway 19a and a notch 19b, which accommodates entry of a complementary rod 24. The notch 19b extends perpendicular to the entryway 19a (e.g., giving rise to a L-shaped structure).

Though, it can be appreciated that filtration discs and/or filter packs may be assembled in any other suitable manner. For example, respective coupling members of filter packs or filtration discs may incorporate a screw or threaded type arrangement that allows for mutual engagement thereof. Alternatively, the filter packs and/or filtration discs may be fitted over an optionally cylindrical core that extends from the top of the filter system to the bottom.

In this embodiment, the lower coupling member 17 located at the bottom of the first filter pack 10 is complementary with the upper coupling member 22 located at the top of the second filter pack 20. For instance, FIG. 7 depicts the casing 18 of the lower coupling member 17 and the head 23 of the upper coupling member 20 both to be cylindrical in structure. In some embodiments, the diameter of the casing or the head may be approximately 1 inch or greater, approximately 2 inches or greater, approximately 3 inches or greater, approximately 4 inches or greater, approximately 5 inches or greater, approximately 7 inches or greater, approximately 10 inches or greater, approximately 15 inches or greater, less than the above noted values, etc. Other dimensions are possible, for example, dimensions that fall within or outside of ranges defined by suitable combinations of the above values. The casing 18 of the upper coupling member 10 has a diameter that may be slightly larger than the head 23 of the lower coupling member 17, allowing for a mutual fit between the casing 18 and the head 23.

Additionally, the rod 24 of the upper coupling member 22 may be inserted into the slot 19 of the lower coupling member 17. The rod 24 may enter through the entryway 19a and the notch 19b may accommodate rotation of the first filter pack 10 relative to the second filter pack 20, for coupling therebetween. That is, when the first and second filter packs 10, 20 are coupled together such that the rod 24 of the second filter pack 20 is situated at the end of the notch 19b, the first filter pack 10 is unable to be lifted from the second filter pack 20. Though, when the first and second filter packs 10, 20 are rotated such that the rod 24 is able to travel along the entryway 19a, the first filter pack 10 may be lifted and separated from the second filter pack 20, for example, via a suitable tool 100 that has a firm grasp on the upper coupling member 12 of the first filter pack 10.

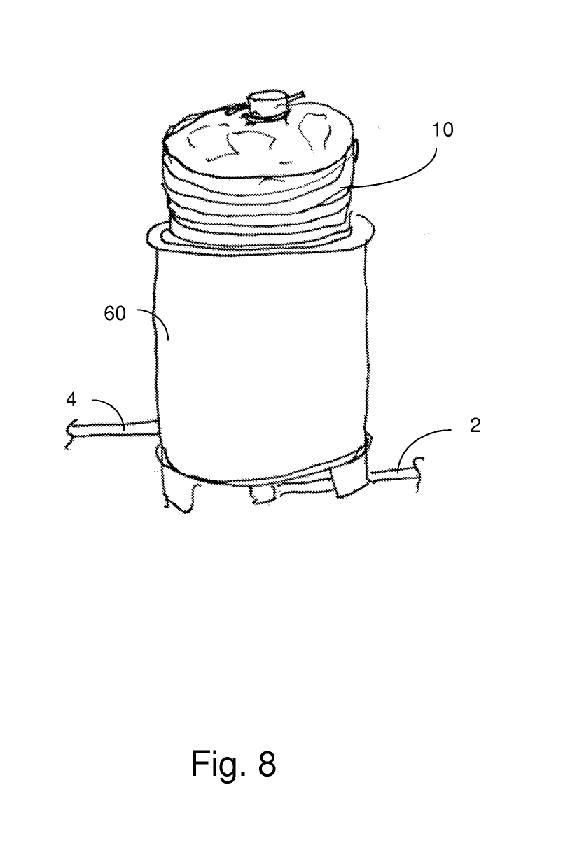

FIG. 8 shows an embodiment of a filtration system including three filter packs similar to the system depicted in FIG. 6, except the upper support sleeve is removed from the top of the lower support sleeve 60. Here, the lower support sleeve 60 surrounds the second and third filter packs as the first filter pack 10 protrudes upward from the lower support sleeve 60. Thus, the lower support sleeve 60 provides mechanical support in stabilizing the second and third filter packs as the first filter pack 10 is decoupled and separated therefrom.

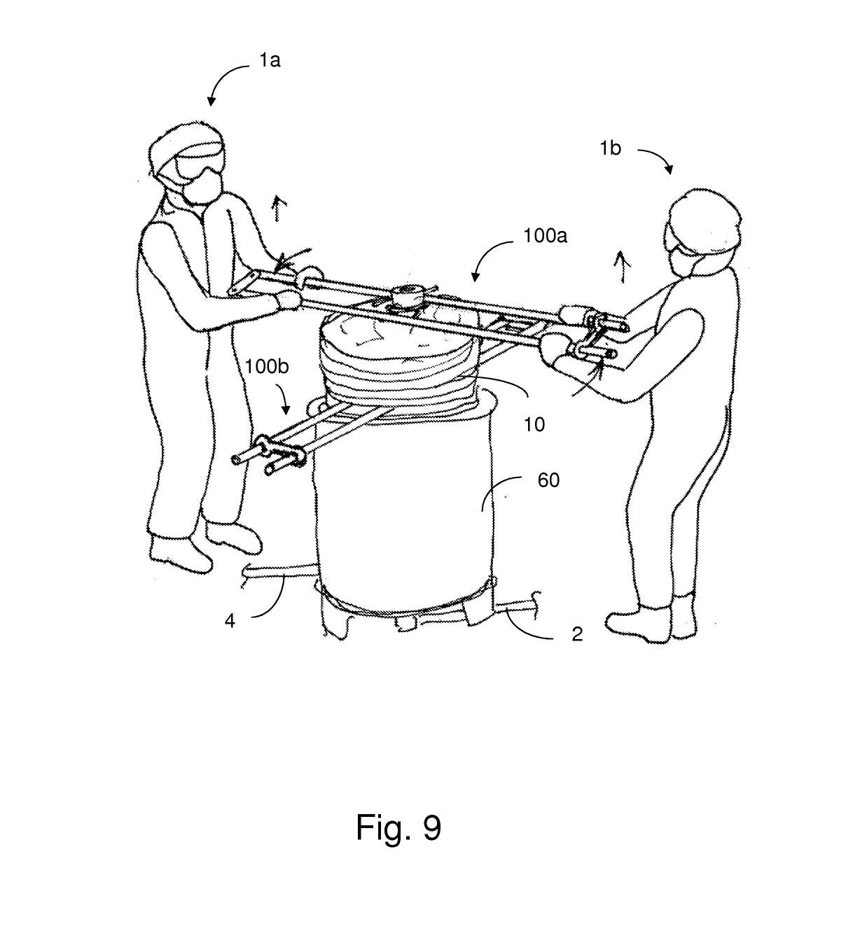

FIG. 9 depicts a schematic showing workers 1a, 1b cooperating together to remove the first filter pack 10 from the second filter pack. As shown, the workers 1a, 1b are each wearing a protective suit, which shields them from exposure to the used filtration discs. As discussed above with respect to its operation, the workers handle the arms so as to open the tool 100a to a non-grasping position, bring the tool 100a into suitable alignment with the first filter pack 10, and close the tool 100a to a grasping position, where the gripping portions are firmly clamped onto a suitable region of the coupling member of the filter pack 10.

As illustrated by the arrows pointing in a counter-clockwise direction (when looking down on to the system from above), the tool 100a together with the filter pack 10 are rotated (e.g., approximately a quarter turn) relative to the filter pack directly underneath, so as to decouple the filter packs from each other. Once suitably decoupled so as to allow vertical movement between the filter packs, the filter pack 10 is lifted off and away from the underlying filter pack.

During this process of manipulating the filter pack 10, as noted above, the support sleeve 60 may provide structural stability for the filter packs contained therein, for example, preventing them from falling over. In some embodiments, and as shown, an additional tool 100b may be optionally used to engage with the coupling member(s) situated between the first (topmost) and second (intermediate) filter packs. That is, the additional tool 100b may be positioned between the first and second filter packs, brought into alignment with the appropriate coupling member (e.g., of the second filter pack), and then suitably clamped thereto with a retaining member set in place for holding the additional tool 100b in place. Accordingly, the additional tool 100b may provide further structural stability for the stack of filter packs, as the topmost filter pack 10 is lifted therefrom.

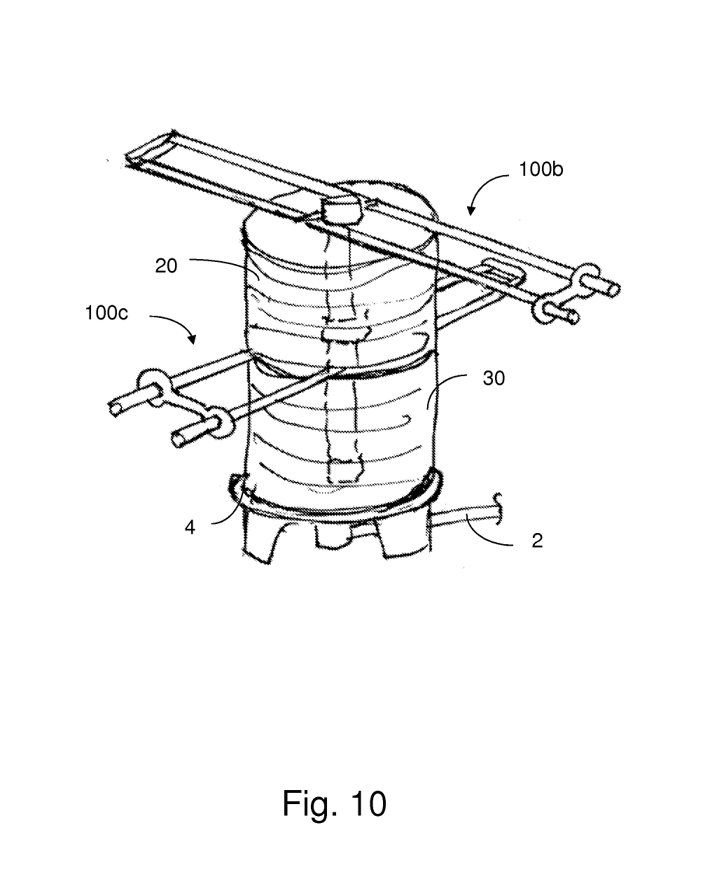

Continuing with this embodiment, once the topmost filter pack is removed, the lower support sleeve 60 may be removed, as shown in FIG. 10. Here, the remaining two filter packs 20, 30 are now exposed. In the absence of a support sleeve, yet another tool 100c may be used to grip the appropriate coupling region to hold the stack of filter packs steady while the second filter pack 20 is separated from the third filter pack 30. Accordingly, as discussed herein, the tool 100b may be used to decouple (e.g., rotate) and lift the second filter pack 20 from the third filter pack 30 in a safe, stable manner.

Embodiments of the present disclosure may be used in cooperation with any suitable filtration system. In some embodiments, the tool may be used to manipulate components of a filtration system (e.g., BIOPAK® filter systems) provided by ErtelAlsop, based at 132 Flatbush Avenue, Kingston, N.Y. 12401. Such filtration systems may employ any appropriate filter media, or combination of filter media components. Non-limiting examples of filter media employed by the BIOPAK® filter system and provided by ErtelAlsop may include filter media according to any of the following product lines: AlphaMedia, MicroMedia: L Series, MicroMedia: XL Series, MicroMedia: LXL Series, MicroClear, Pharmaceutical Grades, amongst others. As noted above, such filter media may include lenticular filter media (e.g., disc-shaped), having diameters of approximately 12 inches, or approximately 16 inches, and extending from a cylindrical polypropylene core.

### EXAMPLE

In a non-limiting example, which is not to be construed as limiting and does not exemplify the full scope of the invention, a BIOPAK® filter system, provided by ErtelAlsop, was assembled and operated according to methods known in the art. The filter system was similar to that shown in the above figures (e.g., FIG. 6), having a lenticular filter media arrangement where three filter packs were coupled to one another. The filter packs included an uppermost filter pack, an intermediate filter pack and a lowermost filter pack, each of the filter packs having six filtration discs provided in a stacked lenticular arrangement. The coupled filter packs were covered with a covering, including a lower support sleeve and a domed upper support sleeve.

When it was determined that operation of the filter system was finished, the filtrate valve located near the outlet was opened to allow for system drainage. To ensure that the system was drained, a nitrogen line was connected to a diaphragm valve located at the top of the assembly. The nitrogen line was set, via a regulator, to between 10-30 psi and the diaphragm valve was opened. The system was then permitted to drain until liquid was no longer observed to flow via the outlet. The nitrogen regulator was then turned off, allowing the pressure within the nitrogen line to return to 0 psi, and the nitrogen line was disconnected from the diaphragm valve.

Using an embodiment of the tool described herein, the filter packs were then removed from the system. The domed upper support sleeve was lifted and removed from the system, exposing the uppermost filter pack, similar to that shown in FIG. 8. The tool was then grasped on opposite sides by two operators.

The operators, in cooperation, lifted the tool and moved the two arms of the tool away from one another, to a non-grasping position. The operators then positioned the respective gripping portions of each of the arms into alignment about the coupling member of the uppermost filter pack. Once in appropriate alignment, the operators moved the arms toward one another to its grasping position so that the gripping portions engaged with the coupling member. The operators rotated the uppermost filter pack counter-clockwise so as to decouple the uppermost filter pack from the intermediate filter pack. The uppermost filter pack was then lifted away from the intermediate filter pack and placed within a containment area for subsequent removal from the facility.

Next, the intermediate filter pack was removed from the system. Accordingly, the lower support sleeve that extended over a portion of the intermediate filter pack was removed. To maintain stability during decoupling and lifting of the intermediate filter pack from the lowermost filter pack, like that shown in FIG. 10, an additional tool was positioned and clamped at the coupling region between the lowermost filter pack and the intermediate filter pack. Similar to how the operators cooperated in handling the tool to remove the uppermost filter pack, the operators worked together to use the tool to decouple the intermediate filter pack from the lowermost filter pack, by rotation of the intermediate filter pack. The intermediate filter pack was then lifted away from the lowermost filter pack and also placed within the containment area.

And finally, the lowermost filter packed was removed from the system. The operators then cooperated in handling the tool so as to decouple the lowermost filter pack from the system by rotation thereof. The lowermost filter pack was then lifted away from the base of the system then placed within the containment area.

Having thus described several aspects of at least one embodiment of the present disclosure, it is to be appreciated various alterations, modifications, and improvements will readily occur to those skilled in the art. For example, the devices described herein may be adapted for use in filtration (e.g., direct, tangential flow) or non-filtration related applications. Alternatively, in addition to removing and/or replacing components, embodiments presented herein may be used to install and/or build components together. Such alterations, modification, and improvements are intended to be part of this disclosure, and are intended to be within the spirit and scope of the present disclosure. Accordingly, the foregoing description and drawings are by way of example only.

What is claimed is:

1. A method of manipulating components of a filtration system, comprising:
moving two adjacent arms of a tool away from one another to a non-grasping position, each of the arms having a respective gripping portion located along the arm;
positioning the gripping portions of each of the arms of the tool into alignment about a coupling member of at least one filtration component;
moving the two adjacent arms of the tool toward one another to a grasping position such that the respective gripping portions of each of the arms engages with the coupling member of the at least one filtration component; and
lifting the tool and the at least one filtration component, via the two adjacent arms engaged with the coupling member, from a substrate.

2. The method of claim 1, wherein corresponding ends of the arms of the tool are pivotally coupled with respect to one another.

3. The method of claim 2, wherein moving the two adjacent arms of the tool away from one another to the non-grasping position includes pivoting the arms away from one another.

4. The method of claim 3, wherein moving the two adjacent arms of the tool toward one another to the grasping position includes pivoting the arms toward one another.

5. (canceled)

6. (canceled)

7. The method of claim 1, further comprising maintaining the arms of the tool in the grasping position by coupling the arms of the tool with a retaining member.

8. The method of claim 1, further comprising decoupling the at least one filtration component from the substrate prior to lifting the at least one filtration component from the substrate.

9. (canceled)

10. (canceled)

11. The method of claim 1, wherein lifting the tool and the at least one filtration component includes separating a first filter pack from a second filter pack.

12. (canceled)

13. The method of claim 11, further comprising covering a portion of the second filter pack with a support sleeve to stabilize the second filter pack during the step of separating the first filter pack from the second filter pack.

14. The method of claim 11, further comprising placing an additional tool between the first filter pack and the second filter pack to stabilize the second filter pack during the step of separating the first filter pack from the second filter pack.

15. The method of claim 14, wherein placing the additional tool between the first and second filter packs includes moving two adjacent arms of the additional tool toward one another to a grasping position such that respective gripping portions of each of the arms of the additional tool engage with a coupling member of the second filter pack.

16.-18. (canceled)

19. A filtration system, comprising:
a first filter pack having a first plurality of stacked filtration discs and a first coupling member located at an upper region of the first filter pack;
a second filter pack having a second plurality of stacked filtration discs and a second coupling member located at an upper region of the second filter pack, the
second coupling member constructed and arranged to engage with a lower region of the first filter pack; and
a tool having adjacent arms constructed and arranged to engage with the first coupling member of the first filter pack, for lifting and separating the first filter pack from the second filter pack.

20. The system of claim 19, wherein the tool includes a first arm having a first gripping portion and a second arm having a second gripping portion;
wherein corresponding ends of the first and second arms of the tool are pivotally coupled with respect to one another; and
wherein the first gripping portion is located substantially equidistant from opposite ends of the first arm and the second gripping portion is located substantially equidistant from opposite ends of the second arm.

21.-25. (canceled)

26. The system of claim 20, further comprising a retaining member configured to couple with and hold the arms of the tool in the grasping position.

27. The system of claim 19, wherein the tool is constructed and arranged to decouple and lift the first filter pack from the second filter pack.

28. (canceled)

29. (canceled)

30. The system of claim 19, further comprising a support sleeve covering a portion of the second filter pack for stabilizing the second filter pack during separation of the first filter pack from the second filter pack.

31. The system of claim 19, further comprising an additional tool located between the first and second filter packs for stabilizing the second filter pack during separation of the first filter pack from the second filter pack.

32.-34. (canceled)

35. A tool for manipulating components of a filtration system, comprising:
a first arm having a first gripping portion; and
a second arm having a second gripping portion, the first and second arms pivotally coupled to one another such that the first and second gripping portions are movable away from one another to a non-grasping position and movable toward one another to a grasping position, wherein the first and second arms are constructed and arranged to engage with a coupling member of at least one filtration component upon reaching the grasping position, for decoupling and lifting of the at least one filtration component from a substrate.

36. The tool of claim 35, wherein corresponding ends of the first and second arms are pivotally coupled to one another.

37. (canceled)

38. The tool of claim 35, wherein the respective gripping portions of the first and second arms are constructed and arranged to clamp on to the coupling member of the at least one filtration component.

39. The tool of claim 35, wherein the first and second arms are configured to extend in respective directions that are substantially parallel relative to one another, when placed in the grasping position.

40.-43. (canceled)
